(19) United States
(12) Patent Application Publication
(10) Pub. No.: US 2015/0078674 A1
(43) Pub. Date: Mar. 19, 2015

(54) COMPONENT SORTING BASED ENCODING FOR 3D MESH COMPRESSION

(71) Applicants: Wenfei Jiang, Beijing (CN); Kangying Cai, Rennes (FR); Jiang Tian, Beijing (CN)

(72) Inventors: Wenfei Jiang, Beijing (CN); Kangying Cai, Rennes (FR); Jiang Tian, Beijing (CN)

(21) Appl. No.: 14/378,333

(22) PCT Filed: Feb. 20, 2012
(86) PCT No.: PCT/CN2012/071334

§ 371 Date: Aug. 13, 2014

(51) Int. Cl. H04N 19/597; H04N 19/124

(52) U.S. Cl. CPC H04N 19/597; H04N 19/124
USPC 382/251

(57) ABSTRACT

A method and an apparatus for 3D model compression are described. Correlation among the components of the 3D model are explored and utilized to increase the compression ratio. A principal parameter is selected and examined for determining a sorting dimension. Components are then sorted according to the sorting dimension. The principal parameter values of the sorted components are incrementally encoded. Other parameters are encoded as usual. The corresponding decoder decodes the principal parameter values of the components incrementally and decodes other parameter values as usual. Further an adaptive bit determination algorithm is disclosed to adaptively determine the number of bits assigned to each parameter value based on the value range thereof and the distortion requirements.

### TECHNICAL FIELD

The present invention generally relates to three dimensional (3D) models. More particularly, it relates to compression and transmission of 3D models in a 3D program.

### BACKGROUND OF THE INVENTION

In practical applications, such as 3D games, virtual chatting, digital museums and CAD, many 3D models consist of a large number of connected components. These multi-connected 3D models usually contain a non-trivial amount of repetitive structures via various transformations, as shown in FIG. 1. An efficient compression method for these kinds of 3D models should be able to explore the repetitive structures and extract redundancy to achieve a high compression ratio.

In PCT application WO2010149492 filed on Jun. 9, 2010, entitled Efficient Compression Scheme for Large 3D Engineering Models, an efficient compression algorithm for multi-connected 3D models by taking advantage of discovering repetitive structures in the input models is disclosed. It first discovers in a 3D model, sets of components repeating in various positions, orientations and scaling factors, known as repetitive structures. Then the repetitive structures in the 3D model are organized using “pattern-instance” representation as shown in FIG. 2. A pattern is the representative geometry of the corresponding repetitive structure. The components belonging to a repetitive structure are called instances or instance components of the repetitive structure and they are represented by their transformations, i.e. the positions, orientations and possible scaling factors, with respect to the corresponding pattern and the pattern identification (pattern ID). Those components that do not belong to any repetitive structures are called unique components.

Typically, the transformation information, including translation, rotation and scaling factors, are compressed independently as shown in FIG. 3. The redundancy in the transformation information of the instances has not heretofore been explored for compression. Moreover, these data are usually compressed with an equal number of quantization bits, which leads to different precision for different components or difference dimensions of data for the same components. In scenarios wherein the same precision is required for all dimensions or all components, the dimensions or components having higher precision may consume unnecessary bits. If those unnecessary bits can be reduced or eliminated, the compression ratio can be further improved.

### SUMMARY OF THE INVENTION

This invention directs to methods and apparatuses for 3D model compression.

The present invention solves the problem of 3D model compression and proposes an algorithm to explore the correlation among the instances and an algorithm for adaptive bit determination to increase the compression ratio of a 3D model.

According to an aspect of the present invention, there is provided a method for encoding components of a 3D model. The method comprises the steps of sorting the components based on a value of a principal parameter; and encoding the sorted components by incrementally encoding the principal parameter.

According to another aspect of the present invention, there is provided a method for decoding components of a 3D model, which comprises the steps of determining a sorting dimension based on a principal parameter that is used for encoding said components; and decoding said components by incrementally decoding the principal parameter.

### BRIEF DESCRIPTION OF THE DRAWINGS

The above features of the present invention will become more apparent by describing in detail exemplary embodiments thereof with reference to the attached drawings in which:

FIG. 1 illustrates 3D models with a large number of connected components and repetitive structures.

FIG. 2 illustrates the process of building “pattern-instance” based 3D model representation.

FIG. 3 illustrates the process of independent encoding of transformation information for instance components.

FIG. 4 shows a block diagram of a 3D component encoder according to the principles of the current invention.

FIG. 5 shows a block diagram of a sorting unit according to one embodiment of the present invention.

FIG. 6 shows a block diagram of a 3D component decoder according to the principles of the present invention.

FIG. 7 shows an example flow chart of the process for incremental encoding of transformation parameters.

FIG. 8 shows an example flow chart of the process for incremental decoding of transformation parameters.

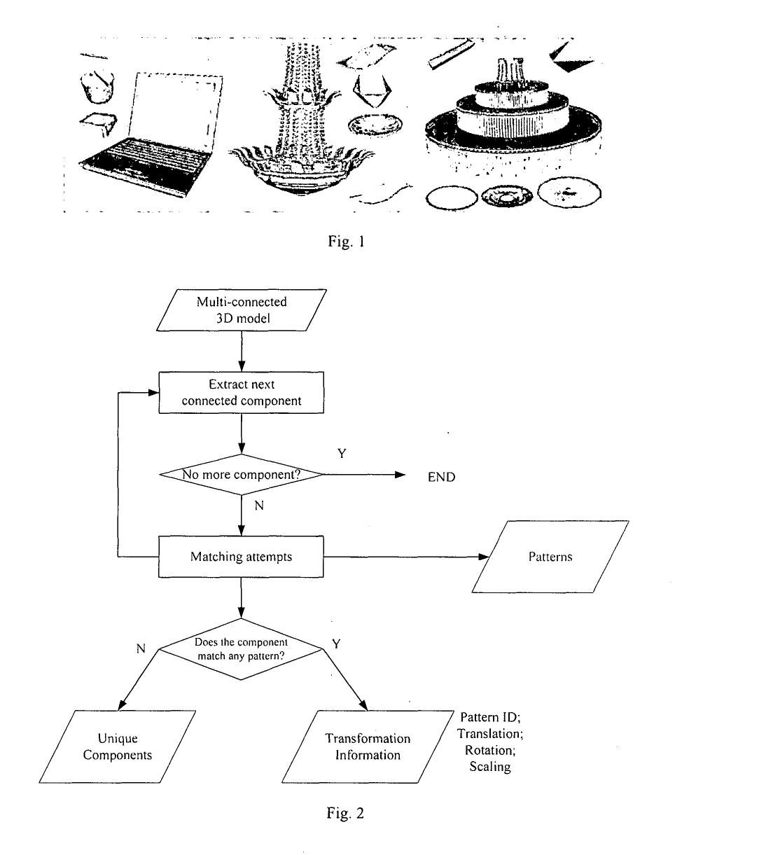

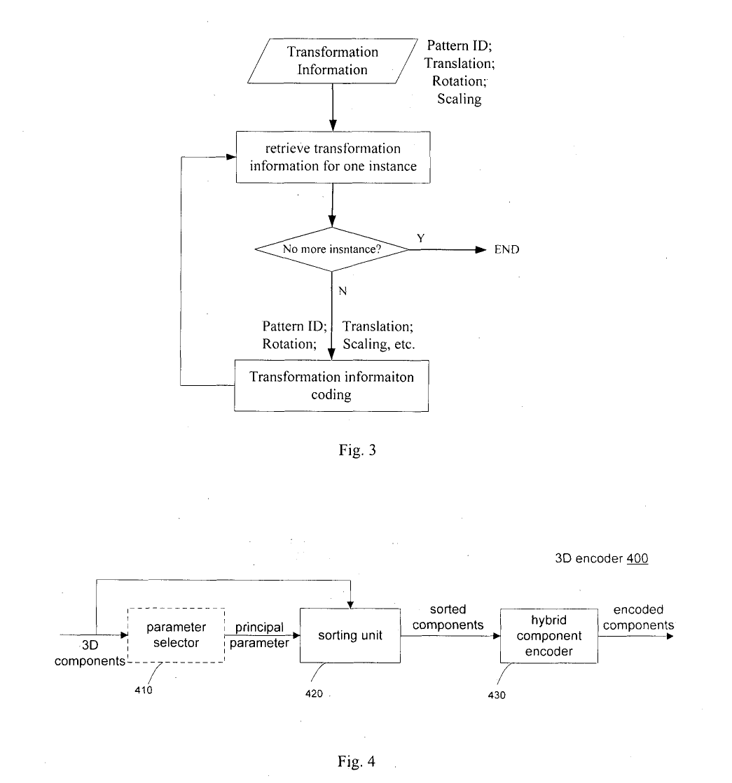

### DETAILED DESCRIPTION

In the present invention, a solution to compressing components of a 3D model is proposed. By introducing prediction techniques among components and adaptive quantization strategy, a higher compression ratio for a 3D model is achieved.

FIG. 4 shows a block diagram of a 3D encoder for encoding components of a 3D model according to the principles of the current invention. It comprises an optional parameter selector 410, a sorting unit 420 and a hybrid component encoder 430. The optional parameter selector selects a principal parameter, according to which the components will be compressed. A principal parameter is one of the component parameters by which the components are sorted and incrementally encoded as will be discussed later. The principal parameter can also be determined beforehand, e.g. by simple agreement between the encoder and decoder or as specified in the coding standards, without going through the parameter selector. The sorting unit sorts these components based on a value of the selected principal parameter. The hybrid component encoder then encodes the sorted components by incrementally encoding the principal parameter. The remaining parameters of these sorted components may be independently encoded by the hybrid component encoder or a normal component encoder.

Note that in this embodiment, components to be compressed share common parameters so that the principal parameter can be selected from among these common parameters, and all the components to be compressed can be sorted based on the selected principal parameters. Example parameters of components can be any numeric parameters to be encoded, including means, eigenvectors, or some vertex features of the components, or any of the transformation information of the instance component in the “pattern-instance” representation as described before. A general guideline for selecting the principal parameters is that the principal parameter should reflect how the components are correlated and its value has a large value set. For example, if the instance components are highly correlated in terms of their positions, the translation parameter in the instance transformation should be selected as the principal parameter. Those parameters, such as a flag in the component parameter, which have only a limited number of values, may not be a good choice for the principal parameters. The sorting of the components can be done based on a value of the principal parameter, e.g. the x-value of the means of the components if component mean is selected as the principal parameter; or the translation value along the z-axis of the instance transformation if translation is selected as the principal parameter for the instance components. In this case, the incremental encoding of the principal parameter can be performed by incrementally encoding the value used for sorting (known as sorting dimension as will be discussed later) while independently encoding other values (non-sorting dimensions). Other embodiments of the principal parameter are possible depending on the representation of the components. In general, when the components to be compressed are correlated, e.g. in terms of geometry or position, incrementally encoding the principal parameter would reduce the overall bitrate of the compressed 3D model.

The hybrid component encoder 430 further comprises a bit calculator for adaptively determining the number of encoding bits for each parameter of the components. For example, the number of bits assigned to a parameter with a smaller value range should be smaller than that of a parameter with a larger value range, given the same distortion requirement.

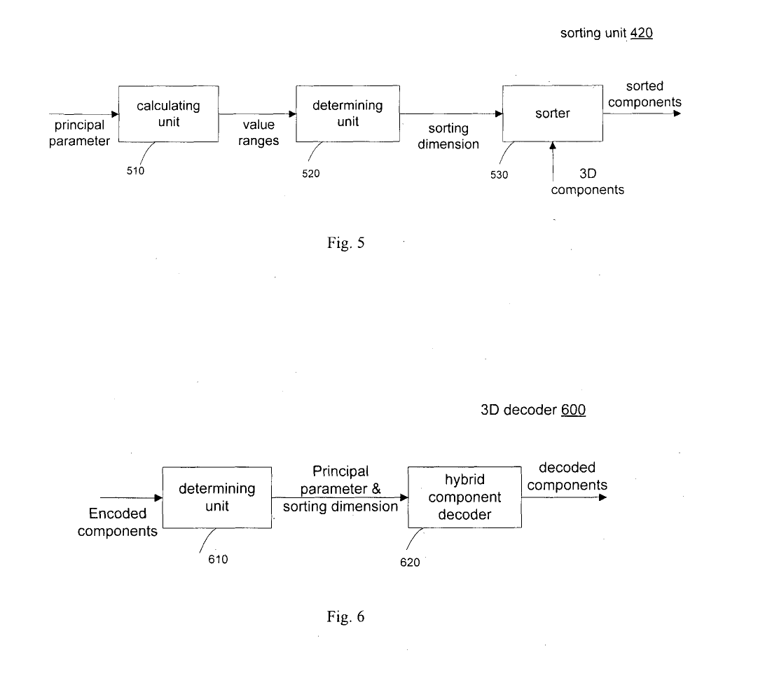

FIG. 5 shows a block diagram of an embodiment of the sorting unit 420. In this embodiment, a calculating unit 510 is employed to calculate the value ranges of the principal parameter. If the principal parameter is one-dimensional data, the components are sorted/ordered according to the ascending (or descending) order of this parameter. If the principal parameter is multi-dimensional data, a determining unit 520 determines which dimension of the principal parameter is the sorting dimension. With the sorting dimension, a sorter 530 sorts the components along the sorting dimension for encoding. In one embodiment, the determining unit 520 calculates the value range of each dimension of the principal parameter, (such as the value range for the x, y, z values of the translation information in the transformation information of the instance components), sorts the components by the values along each dimension, and then calculates the value range of the difference values of the adjacent sorted components. The dimension which has the smallest ratio of the difference range to the original value range is chosen as the sorting dimension. Note that this embodiment requires several sorting steps, which can be computationally expensive. To reduce the computational overhead, according to another embodiment of the invention, the dimension with the smallest value range is chosen as the sorting dimension so that the components are sorted to have ascending or descending values along that dimension.

FIG. 6 depicts a block diagram of the 3D decoder for decoding the components of a 3D model according to the principles of the current invention. In this embodiment, a determining unit 610 identifies the principal parameter, if necessary, and calculates the sorting dimension that has been used for encoding the components. Then a hybrid component decoder 620 decodes the components by incrementally decoding the principal parameter. In one embodiment, the incremental decoding of the principal parameter decodes the data along the sorting dimension incrementally while decoding the data along other dimensions independently. The hybrid decoder further decodes the remaining parameters of the components independently.

The following presents a preferred detailed embodiment of the 3D model compression according to the present invention, which employs pattern-instance 3D model representation as an example for the embodiment. Other 3D model representations would also apply. For explanation purposes, the transformation information for the “pattern-instance” based 3D model is selected as example parameters for compression. Several major steps of this embodiment are:

1. The encoder sorts the instances in ascending (or descending) order of a certain transformation parameter (orientation, translation or scaling), which is called a principal parameter.

2. The dimension of the principal parameter which covers the smallest range of values is employed as the sorting dimension for the above sorting.

3. The values of the principal parameter along the sorting dimension are incrementally encoded rather than independently encoded.

4. The number of quantization bits for each parameter is determined adaptively based on the maximum and minimum values of each corresponding parameter.

### Quantization Bit Determination

Typically, all dimensions of multi-dimensional data in a 3D model, e.g., the vertex coordinates of 3D models, are compressed with an equal number of quantization bits if fixed-length coding is employed. For example, for a tall 3D model with a size of 100×200×500, if the quantization bit for the geometry (i.e., vertex positions) is 12, the quantization steps for the three axes would be 100/2¹², 200/2¹² and 500/2¹². Suppose the original vertex position is (x, y, z) while the decoded version is (x′, y′, z′), then the possible distortions along the x, y and z axes are:

$$\begin{matrix}\vert x - {x}^{′} \vert \leq \frac{100}{{2}^{12} \times 2} = 0.0122 & ( 1 ) \\ \vert y - {y}^{′} \vert \leq \frac{200}{{2}^{12} \times 2} = 0.0244 & ( 2 ) \\ \vert z - {z}^{′} \vert \leq \frac{500}{{2}^{12} \times 2} = 0.0610 & ( 3 )\end{matrix}$$

In most applications, it is unnecessary to represent a 3D model with different precision along different axes. Typically, one same precision requirement applies to all dimensions/axes. Thus, in the above example, 12-bit assignment to the vertex position guarantees a distortion lower than 0.061 for all dimensions/axes. In that case, higher precisions or lower distortion along the x and y axes are not necessary and fewer bits could have been assigned to x and y vertex coordinates. The adaptive quantization strategy as disclosed in the present invention would achieve this goal.

According to one embodiment of the present invention, the encoder determines the number of quantization bits for the parameters based on their value ranges and the precision/distortion requirement. Typically, the precision requirement is reflected in the quality requirement of the reconstructed model. The encoder calculates the maximum acceptable distortion for each parameter based on the quality requirement. For example, the maximum acceptable distortion for the translation parameter is distₘₐₓ, and the maximum and minimum translation values of all instances along x, y and z axes are (xₘₐₓ, xₘᵢₙ), (yₘₐₓ, yₘᵢₙ), and (zₘₐₓ, zₘᵢₙ), respectively. The number of quantization bits for the x, y and z axes can be determined as:

$$\begin{matrix}{quant\_bits}_{x} = ⌈ {log}_{2} \frac{{x}_{max} - {x}_{min}}{{dist}_{max}} ⌉ - 1 & ( 4 ) \\ {quant\_bits}_{y} = ⌈ {log}_{2} \frac{{y}_{max} - {y}_{min}}{{dist}_{max}} ⌉ - 1 & ( 5 ) \\ {quant\_bits}_{z} = ⌈ {log}_{2} \frac{{z}_{max} - {z}_{min}}{{dist}_{max}} ⌉ - 1 & ( 6 )\end{matrix}$$

Compared with the equal bit assignment, the adaptive bit assignment of Eqns. (4)-(6) can improve the compression ratio while meeting the distortion requirement.

### Principal Parameter and Instance Sorting

General criteria for determining a principal parameter are, but not limited to: 1. the bit consumption of the principal parameter shall be significant in the bitstream; 2. the values of the principal parameter shall be distributed as uniformly as possible. Based on the criteria, in the embodiment wherein the pattern-instance representation is used to represent the components, the translation parameter and the rotation parameter are possible candidates for the principal parameter. If a multi-dimensional parameter such as the translation or the rotation of the transformation information of an instance is chosen as the principal parameter, one of its dimensions can be used as the sorting dimension. In a different embodiment, multiple dimensions can be utilized to determine how the components are sorted. In the embodiment wherein one dimension is employed for sorting, the data along this dimension is compressed incrementally. An ideal situation is that the values are distributed evenly so that the value range of the difference between adjacent values can be small and thus require a small number of bits. In general, this case is more likely to happen if the range of the values is small. Thus, in one implementation, the dimension of the parameter which covers the smallest range of values is chosen as the sorting dimension.

Suppose the translation parameter (x, y, z) is the principal parameter, and the value ranges for the translation parameter along three dimensions are

rangeₓ=xₘₐₓ-xₘᵢₙ, range_{y}=yₘₐₓ-yₘᵢₙ, and range_{z}=zₘₐₓ-zₘᵢₙ.

If rangeₓ>range_{z}>range_{y}, the instances are placed in an ascending (or descending) order according to the values on the y axis first, then z axis, and then x axis during sorting. That is, the priority of the axes for sorting follows priority_{y}>priority_{z}>priorityₓ. When two or more of the value ranges are equal, e.g. rangeₓ=range_{y}, the priority of the axes for sorting can be pre-determined and agreed upon between the encoder and the decoder or can be transmitted in the bitstream. For example, it can be determined before encoding that the priority follows priorityₓ>priority_{z}>priority_{y} as a tie-breaker when the value ranges for the axes are equal.

### Encoding

After the instances are sorted along one of the parameters, known as the principal parameter, the values of this particular parameter can be encoded incrementally. Denote the principal parameter as P=[Pₓ, P_{y}, P_{z}] and the value along p axis is selected as the sorting dimension, and pε{x, y, z}. The encoder encodes the difference value along the p axis, diffᵢ=P_{Pi}−P_{Pi-1}, instead of the value P_{Pi} for the ith instance and i=1, . . . , n assuming there are a total of n instances. To incrementally encode P_{P1}˜P_{Pn}, the encoder goes through the following steps:
1. Set P_{P0}=0; calculate pre_diff₁˜pre_diffₙ as pre_diffᵢ=P_{Pi}−P_{Pi-1}.
2. Determine the number of quantization bits for diff₁˜diffₙ based on the maximum and minimum values of pre_diff₁˜pre_diffₙ.
3. Set P_rec_{P0}=0. For i=1˜n
   Calculate diffᵢ=P_{Pi}−P_rec_{Pi-1};
   Quantize diffᵢ into diff_quantᵢ, and encode diff_quantᵢ;
   De-quantize diff_quantᵢinto diff_dequantᵢ;
   Reconstruct P_{Pi} as P_rec_{Pi}=P_rec_{Pi-1}+diff_dequantᵢ;
   i=i+1;
End

The following is an example of encoding a component using translation parameter as the principal parameter:

xₘₐₓ=0.68; xₘᵢₙ=0.11; rangeₓ=0.56;

yₘₐₓ=0.96; yₘᵢₙ=0.24; range_{y}=0.72;

zₘₐₓ=0.67; zₘᵢₙ=0.12; range_{z}=0.55.

Since z axis has the smallest range of the parameter value, z axis is chosen as the sorting dimension.

After the sorting, the increment data of the translation on z axis is:

diffₘₐₓ=0.02; diffₘᵢₙ=0; range_{diff}=0.02,

The distortion requirement requires that the decoding error distₘₐₓ<10⁻⁴. Then the number of quantization bits for each dimension can be determined as:

$$\begin{matrix}{quant\_bits}_{x} = ⌈ {log}_{2} \frac{0.56}{{dist}_{max}} ⌉ - 1 = 12 \\ {quant\_bits}_{y} = ⌈ {log}_{2} \frac{0.72}{{dist}_{max}} ⌉ - 1 = 12 \\ {quant\_bits}_{z} = ⌈ {log}_{2} \frac{0.55}{{dist}_{max}} ⌉ - 1 = 12 \\ {quant\_bits}_{diff} = ⌈ {log}_{2} \frac{0.02}{{dist}_{max}} ⌉ - 1 = 7\end{matrix}$$

It can be seen that the bit consumption for encoding the translation parameter of an instance is reduced from 12+12+12=36 without the incremental encoding to 12+12+7=31 by employing the sorting and incremental encoding for the instances according to the present invention. The bit saving is 14% in this example.

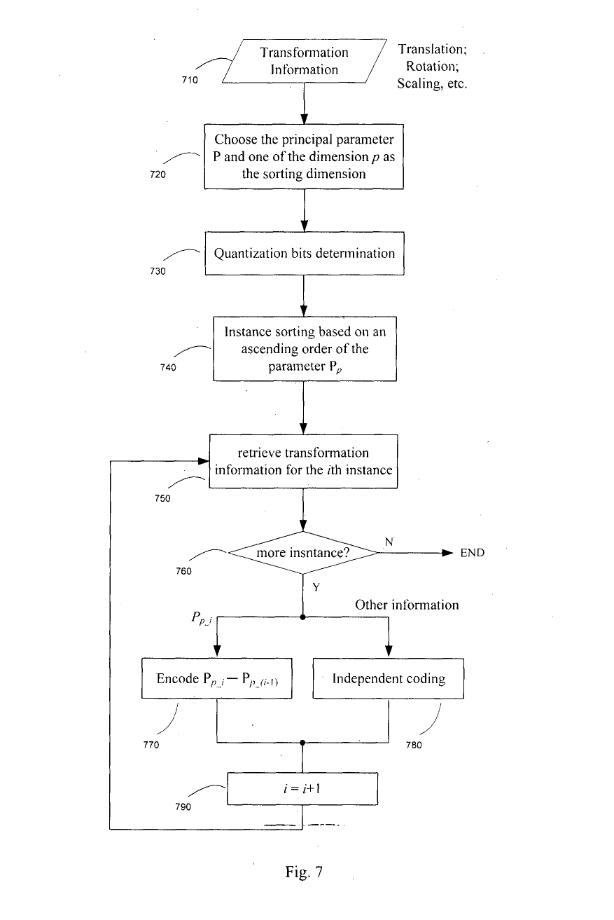

FIG. 7 summarizes an example flow chart of the process for incremental encoding of transformation parameters. In step 720, a principal parameter P is selected or pre-determined from the transformation information 710, which contains parameters such as translation, rotation, scaling etc. One dimension p of P is further selected as the sorting dimension in 720. In step 730, the quantization bits are determined for each dimension of the parameters. For the sorting dimension p, the quantization bits are determined based on the range of the difference values; while for other dimensions of the principal parameter and other parameters, the quantization bits are determined based on the range of the values of the parameters. The instances are sorted in 740 based on the selected sorting dimension, i.e. the dimension p of the principal parameter P, in an ascending or a descending order. The transformation information of each instance is examined and compressed by going through steps 750 to 790. Step 750 retrieves the transformation information for the ith instance and if it is valid instance transformation information which means there are still instances unexamined, the process moves onto step 770 or 790. Otherwise, it means that all instances have been examined and the process ends. With the valid instance transformation, the value along the sorting dimension is encoded incrementally in step 770 and all other information is encoded independently in step 780. The process moves onto the next instance by increasing the index i in step 790.

### Decoding

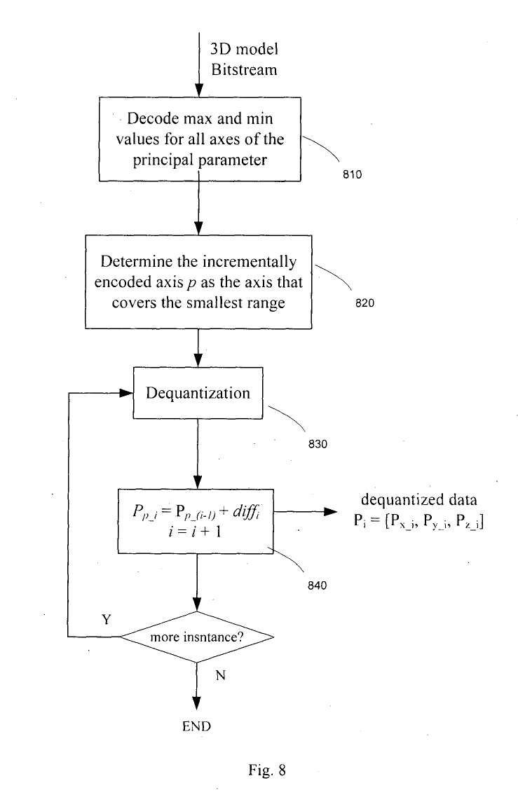

The corresponding decoding process of the instance transformation information which has been encoded incrementally as disclosed above is shown in FIG. 8. The decoder first decodes the maximum and minimum values of the principal parameter data along all dimensions in step 810. The principal parameter may have been agreed upon between the encoder and decoder beforehand, or it may be encoded in the bitstream so that the decoder knows which parameter is the principal parameter before the decoding. For the data which are fixed-length coded, the encoder normally writes their maximum and minimum values into the bitstream. Then the decoder can set up the de-quantizer according to the quality parameter and the maximum and minimum values. In certain embodiment of the present invention, wherein the components are represented by the pattern and the transformation information, the maximum and minimum values of the encoded data for the principal parameter are already encoded as the header. Thus the maximum and minimum values of each parameter can be decoded directly from the bitstream. In a different embodiment wherein the maximum and minimum values of the parameters are not encoded in the bitstream according to the existing codec, such information can be encoded into the bitstream along with the incrementally encoded parameters. Since the information on the maximum and minimum values of the principal parameter is used to determine the sorting dimension, a different implementation of the proposed encoder could encode an identification of the principal parameter and sorting dimension so that the decoder knows the principal parameter and the sorting dimension during decoding. With the decoded maximum and minimum values for the encoded data of the principal parameter, step 820 determines that the axis which covers the smallest range as the incrementally encoded axis p and its encoded values are the difference values between the adjacent values. For the other two axes, parameter values are encoded directly and thus will be decoded as normal. Step 830 de-quantizes the encoded values for the parameter. For the incrementally encoded dimension p, step 840 further decodes the parameter value as P_{Pi}=P_{Pi-1}+diffᵢ. Index i is then increased by one and next encoded instance will be decoded.

The decoding process of the principal parameter is summarized as follows:
1. Decoding the maximum and minimum values of the parameter along three axes.
2. Determine the axis which covers the smallest range as the sorting dimension and its value is incrementally coded at the encoder side.
3. Determine the number of quantization bits of all axes. In a typical codec, there is an approximate mapping relationship between the quality parameter and distortion requirement distₘₐₓ. Thus, the decoder could calculate the (de)quantization step based on the decoded quality parameter for the normally encoded axes. For the incrementally coded dimension, the quantization bits can be calculated by:

$${quant\_bits}_{diff} = {quant\_bits}_{normal} - ⌊ {log}_{2} \frac{max ( {range}_{x} , {range}_{y} , {range}_{z} )}{{range}_{diff}} ⌋ ,$$

where quant_bits_{diff} is the number of quantization bits for the incrementally encoded dimension; quant_bitsₙₒᵣₘₐₗ is the number of the quantization bits for the normally encoded dimensions determined by the quality parameter, which is used for the dimension covering the widest range; max (rangeₓ, range_{y}, range_{z}) is the maximum value range among all three dimensions for the parameter which can be obtained from step 1; and range_{diff} is the value range of the incrementally encoded dimension which can also be obtained from step 1.
4. Decode the incrementally coded axis p as follows and decode other axes as normal.
   Set P_dec_{P0}=0;
   For i=1˜n
      retrieve the next symbol diff_quantᵢ from the bitstream;
      De-quantize diff_quantᵢ,into diff_dequantᵢ;
      Reconstruct P_dec_{Pi} as P_dec_{Pi}=P_dec_{Pi-1}+diff_dequantᵢ;
      i=i+1;
   End
P_dec_{P0}˜P_dec_{Pn} are the decoded data for the principal parameter along p axis. Other parameters will be decoded as normal depending on the specific codec.

It is to be understood that the present invention should not be limited only to the 3D model compression. The principles of the present invention apply broadly to scenarios where the order of the components or objects in the data to be encoded does not affect the decoding results. In that case, the objects can be sorted/ordered in favor of compression. If the values in one of the data fields are approximately evenly distributed, the objects can be sorted/ordered by the values in this data field; and then this particular data field can be encoded incrementally to achieve bit savings.

Although preferred embodiments of the present invention have been described in detail herein, it is to be understood that this invention is not limited to these embodiments, and that other modifications and variations may be effected by one skilled in the art without departing from the scope of the invention as defined by the appended claims.

1. A method for encoding components of a 3D model, comprising:
sorting said components based on a value of a principal parameter; and
encoding said sorted components by incrementally encoding said principal parameter.

2. The method of claim 1, wherein said encoding components step further comprises:
encoding other parameters of said components independently.

3. The method of claim 1, wherein said sorting step comprises:
calculating a value range for each dimension of said principal parameter;
determining a sorting dimension based on said calculated value ranges; and
sorting said components using the determined sorting dimension.

4. The method of claim 3, wherein said sorting dimension is a dimension of said principal parameter whose value range is the smallest.

5. The method of claim 4, wherein said value range is calculated using one of (a) a value of said each dimension of said principal parameter, and (b) a difference value of said each dimension of said principal parameter.

6. The method of claim 1, wherein said encoding components step further comprises:
determining a number of encoding bits for each parameter of said components.

7. The method of claim 1, wherein said components are represented as instances in a pattern-instance representation and said principal parameter is from transformation information of said instances.

8. The method of claim 7, wherein said transformation information comprises translation parameters, rotation parameters, and scaling parameters.

9. The method of claim 8, wherein said principal parameter is one of translation parameters and rotation parameters.

10. A method for decoding components of a 3D model, comprising:
determining a sorting dimension based on a principal parameter that is used for encoding said components; and
decoding said components by incrementally decoding said principal parameter.

11. The method of claim 10, further comprising:
decoding other parameters of said components independently.

12. A 3D encoder for encoding components of a 3D model, comprising:
a sorting unit for sorting said components based on a value of a principal parameter; and
a hybrid component encoder for encoding said sorted components by incrementally encoding said selected principal parameter.

13. The 3D encoder of claim 12, wherein said hybrid component encoder encodes other parameters of said components independently.

14. The 3D encoder of claim 12, wherein said sorting unit comprises:
a calculating unit for calculating a value range for each dimension of said principal parameter;
a determining unit for determining a sorting dimension based on said calculated value ranges; and
a sorter for sorting said components using the determined sorting dimension.

15. The 3D encoder of claim 14, wherein said sorting dimension is a dimension of said principal parameter whose value range is the smallest.

16. The 3D encoder of claim 15, wherein said calculating unit calculates said value range using one of (a) a value of said each dimension of said principal parameter, and (b) a difference value of said each dimension of said principal parameter.

17. The 3D encoder of claim 12, wherein said hybrid component encoder further comprises:
a bit calculator for determining a number of encoding bits for each parameter of said components.

18. The 3D encoder of claim 12, wherein said components are represented as instances in pattern-instance representation and said principal parameter is from transformation information of said instances.

19. The 3D encoder of claim 18, wherein said transformation information comprises translation parameters, rotation parameters, and scaling parameters.

20. The 3D encoder of claim 19, wherein said principal parameter is one of translation parameters and rotation parameters.

21. A 3D decoder for decoding components of a 3D model, comprising:
a determining unit for determining a sorting dimension based on a principal parameter that is used for encoding said components; and
a hybrid component decoder for decoding said components by incrementally decoding said principal parameter.

22. The 3D decoder of claim 21, wherein said hybrid component decoder decodes other parameters of said components independently.
